(19) United States
(12) Patent Application Publication
(10) Pub. No.: US 2005/0046382 A1
(43) Pub. Date: Mar. 3, 2005

(54) Battery engagement structure for portable battery charging module

(75) Inventors: Chin-Ku Chuang, Taipei (TW); Wen-Chieh Wang, Taipei (TW); Chao-Ming Huang, Taipei (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei (TW)

(21) Appl. No.: 10/698,455

(22) Filed: Nov. 3, 2003

(30) Foreign Application Priority Data
Aug. 26, 2003 (TW) 92215419

(51) Int. Cl. H02J 7/00

(52) U.S. Cl. 320/107

(57) ABSTRACT

A battery engagement structure used in a portable battery charging module is disclosed to include a housing accommodating an operation mechanism and a button such that when a battery pack inserted into the battery engagement opening at the housing, the locking bar of the operation mechanism is pushed away by the inserted battery pack. Pressing the button with the hand after charging, the locking bar is moved away from the battery engagement opening to unlock the battery pack. The moving direction of the locking bar is reversed to the pressing movement of the button by means of the action of the link of the operation mechanism, therefore the component parts of the battery charging module can be freely arranged to fully utilize the internal space of the module.

### BACKGROUND OF THE INVENTION

1. Field of the Invention

The present invention relates to a portable battery charging module and, more specifically, to the battery engagement structure used in a portable battery charging module and adapted to lock a battery pack for charging.

2. Description of Related Art

The battery charging system of a portable computer is provided inside the mainframe, and adapted to charge the battery during the use of the AC power socket.

Following the development of high technology, improved battery charging modules are developed. A battery charging module generally comprises a battery engagement opening adapted to receive the battery pack to be charged, a battery engagement structure adapted to engage the battery pack to be charged for charging, and power input/output terminals. The power input terminal is connectable to external power source for charging.

The aforesaid battery engagement structure generally comprises a locking bar and a control button. The control button is operated to move the locking bar to the locking position to lock the inserted battery pack for charging. Because the moving direction of the locking bar in the battery charging module is same as the control button, pressing the control button causes the locking bar to move in the same direction. This design requires much internal space to accommodate the control button and the locking bar and their movement. Further, the control button and the locking bar must be arranged in close proximity to each other to facilitate the action. Due to the aforesaid problem, the arrangement of the component parts of the portable battery charging module must consider the space for the operation of the battery engagement structure.

### SUMMARY OF THE INVENTION

It is the main object of the present invention to provide a battery engagement structure, which requires less installation space in the portable battery charging module, for enabling the internal space of the portable battery charging module to be fully utilized.

To achieve this and other objects of the present invention, the battery engagement structure comprises a housing, a button, an operation mechanism, and a spring member. The housing comprises a bottom panel, a first side panel, and a second side panel, the first side panel having an inner face, the second side panel abutted against one end of the first side panel, a battery engagement opening disposed at the first side panel, a sliding groove disposed at the first side panel in parallel to the inner face of the first side panel, a button hole disposed at the second side panel, and a pivot holder upwardly extended from the bottom panel adjacent to the connection area between the first side panel and the second side panel. The button is mounted in the button hole. The operation mechanism comprises a locking bar and a link. The locking bar is mounted in the sliding groove and movable along the sliding groove in and out of the battery engagement opening, having a front end insertable into the battery engagement opening. The link has a first end, a second end, and a middle part, the first end coupled to the locking bar, the second end stopped against the button, and the middle part pivoted to the pivot holder. The spring member is adapted to impart a prestress to the locking bar to force the front end of the locking bar inserted into the battery engagement opening.

When charging a battery pack, insert the battery pack into the battery engagement opening. At this time, the battery pack pushes the locking bar of the operation mechanism toward the inside of the housing, and at the same time, the spring member imparts a prestress to the locking bar, thereby causing the front end of the locking bar to be moved into the battery engagement opening to engage the battery pack, and therefore the battery pack is locked in the charging position.

After charging, press the button to pull the link to cause the locking bar outwards moving from the battery engagement opening toward the inside of the housing and to further unlock the battery pack, for enabling the battery pack to be removed from the engagement structure of the portable battery charging module.

As indicated above, when pressing the button, the locking bar outwards from the battery engagement opening in a direction reversed or inclined to the direction of the press motion of the button. Therefore, the invention fully utilizes the internal space of the portable battery charging module, eliminating the drawback of the prior art design in which the button and the locking member are arranged in close proximity to each other.

### BRIEF DESCRIPTION OF THE DRAWINGS

FIG. 1 is a schematic drawing showing an application example of the present invention.

FIG. 2 is a perspective assembly view of the preferred embodiment of the present invention.

FIG. 3 is an exploded view of the preferred embodiment of the present invention.

FIG. 4 is a schematic operational view showing the button pressed, the locking bar moved away from the battery engagement opening according to the present invention.

### DETAILED DESCRIPTION OF THE PREFERRED EMBODIMENT

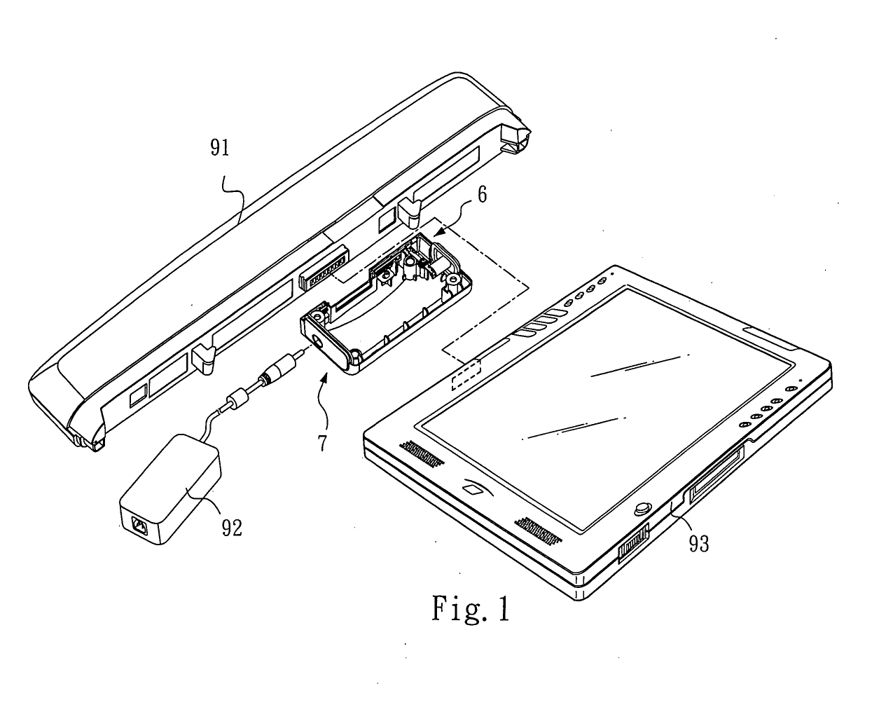

FIG. 1 is a schematic drawing showing an application example of the present invention, in which the reference number 91 indicates a battery pack; the reference number 92 indicates an external power cable 92; the reference number 93 indicates a tablet PC; the reference number 7 indicates a portable battery charging module. The portable battery charging module 7 comprises an engagement structure 6. When in use, the battery pack 91 is connected to the tablet PC 93 to provide the tablet PC 93 with the necessary working voltage. When power low, the battery pack 91 is disconnected from the tablet PC 93, and then connected to the portable battery charging module 7 for charging. At this time, the engagement structure 6 of the portable battery charging module 7 engages the battery pack 91, for enabling the battery pack 91 to be charged by the internal charging circuit (not shown) of the portable battery charging module 7 with power obtained from external power source through the external power cable 92.

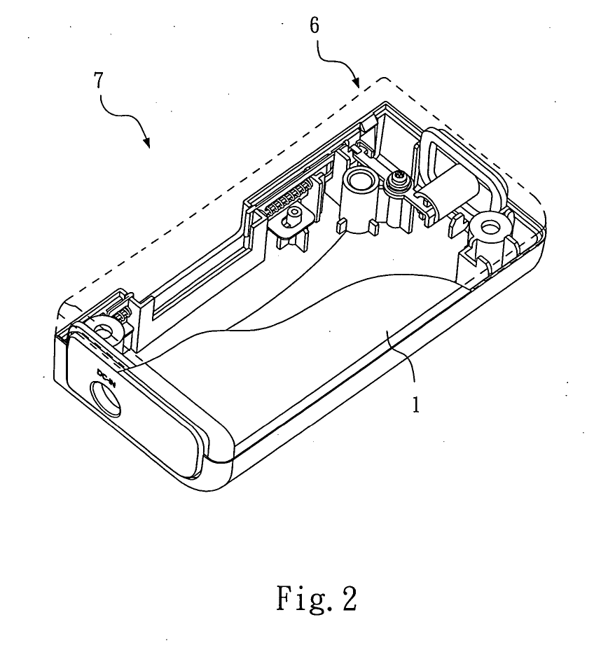

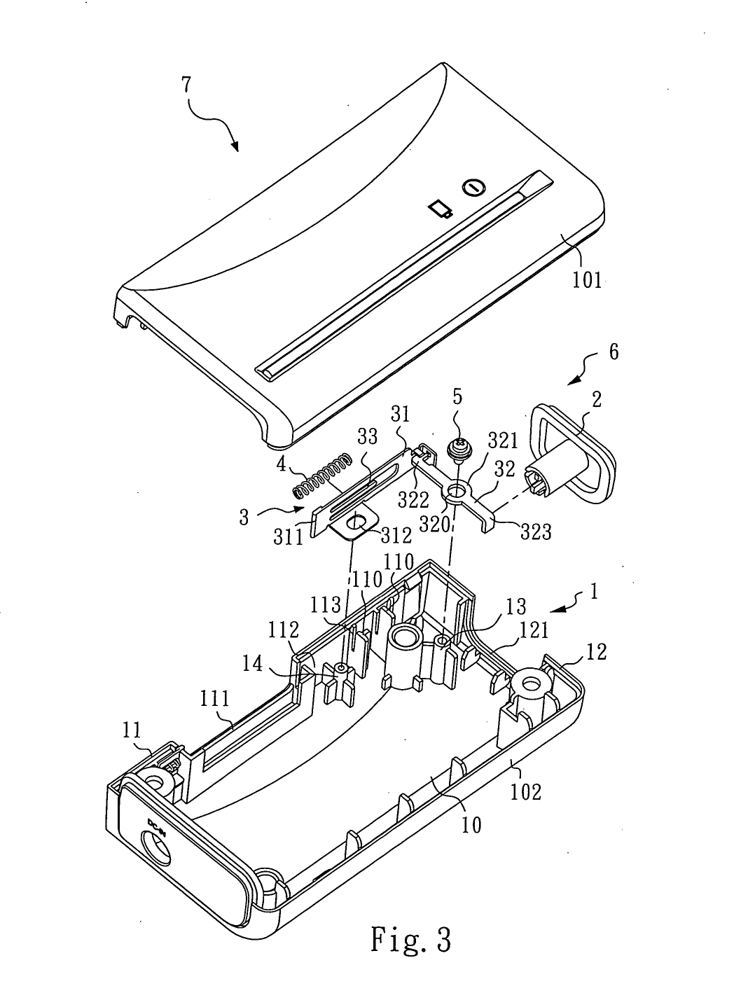

Referring to FIGS. 2 and 3, and FIG. 1 again, the engagement structure 6 comprises a housing 1, a button 2, an operation mechanism 3, and a spring member 4. The housing 1 is formed of a top cover shell 101 and a bottom shell 102., having a bottom panel 10, a first side panel 11, and a second side panel 12. The bottom panel 10 is formed in the bottom shell 102. The first side panel 11 has a battery engagement opening 111, an inner face 112, a sliding groove 113 disposed in parallel to the inner face 112, and two ribs 110 inwardly protruded from the inner face 112. The sliding groove 113 is formed in the ribs 110. The second side panel 12 is abutted against one end of the first side panel 11, having a button hole 121 adapted to accommodate the button 2. The housing 1 further comprises a pivot holder 13 upwardly extended from the bottom panel 10 adjacent to the connection area between the first side panel 11 and the second side panel 12, and a guide rod 14 upwardly extended from the bottom panel 10 adjacent to the first side panel 11.

As illustrated, the button 2 is mounted in the button hole 121. The operation mechanism 3 is comprised of a locking bar 31, and a link 32. The locking bar 31 is slidably mounted in the sliding groove 113 inside the housing 1 in parallel to the first side panel 11, having a front end 311 insertable into the battery engagement opening 111, a supporting rod 33, and an oblong guide hole 312. The oblong guide hole 312 is coupled to the guide rod 14. Further, the link 32 of the operation mechanism 3 has a middle part 321, a first end 322, and a second end 323. The middle part 321 defines a pivot hole 320. A screw 5 is inserted through the pivot hole 320 and threaded into the pivot holder 13 to pivotally secure the link 32 to the pivot holder 13, keeping the first end 322 of the link 32 movably coupled to the locking bar 31 and the second end 323 stopped at the button 2.

Further, the spring member 4 has one end supported on the supporting rod 33 of the locking bar 31 and the other end stopped against one rib 110, imparting a prepress to the locking bar 31 to force the front end 311 of the locking bar 31 inserted into the battery engagement opening 111.

Referring to FIG. 4 and FIGS. 1 and 3 again, when charging the battery pack 91, insert the battery pack 91 into the battery engagement opening 111. At this time, the battery pack 91 pushes the locking bar 31 of the operation mechanism 3 toward the inside of the housing 1, and at the same time, the spring member 4 imparts a prestress to the locking bar 31, thereby causing the front end 311 of the locking bar 31 to be moved into the battery engagement opening 111 to engage the battery pack 91, and therefore the battery pack 91 is locked in the charging position.

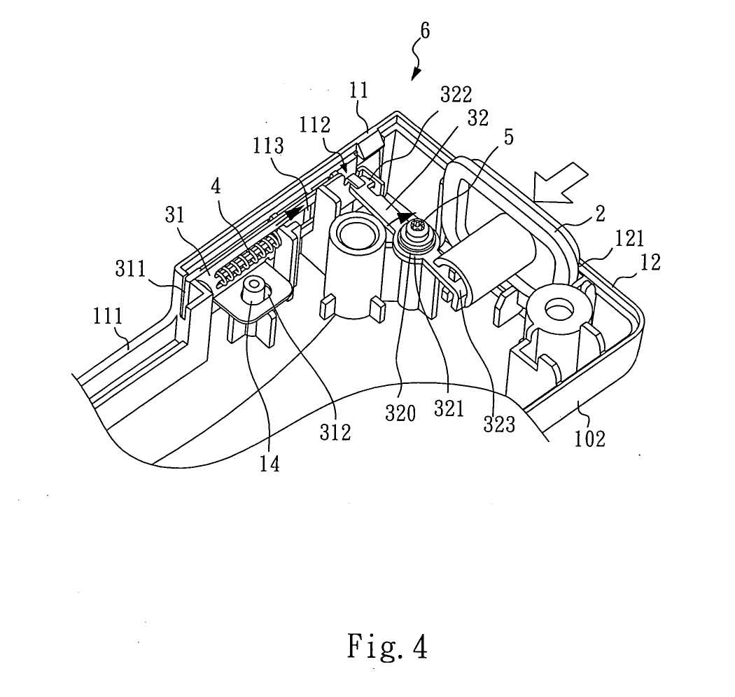

After charging, press the button 2, as shown in FIG. 4, at this time the link 32 is turned about the pivot holder 13 to pull the locking bar 31 outwards from the battery engagement opening 111 in direction reversed to the direction of the press motion of the button 2 (see the moving direction indicated by the arrowhead signs in FIG. 4) and to further unlock the battery pack 91, for enabling the battery pack 91 to be removed from the engagement structure 6 of the portable battery charging module 7. During sliding action of the locking bar 31, the oblong guide hole 312 and the guide rod 14 guide the movement of the locking bar 31 in course.

As indicated above, when pressing the button 2, the link 32 is turned about the pivot holder 13 to pull the locking bar 31 outwards from the battery engagement opening 111 in a direction different from the direction of the press motion of the button 2. According to this embodiment, the operation mechanism 3 is so designed that the locking bar 31 is moved in direction reversed to the direction of the press motion of the button 2. By means of angle or shape design of the link 32, the operation mechanism 3 can be made to let the locking bar 31 move in an oblique direction upon pressing of the button 2 by the user. Therefore, proper arrangement of the button 2 and the locking bar 31 in the portable battery charging module 7 with the link 32 coupled between the button 2 and the locking bar 31 achieves quick engagement of a battery pack. Therefore, the invention fully utilizes the internal space of the portable battery charging module 7, eliminating the drawback of the prior art design in which the button and the locking member are arranged in close proximity to each other.

Although the present invention has been explained in relation to its preferred embodiment, it is to be understood that many other possible modifications and variations can be made without departing from the spirit and scope of the invention as hereinafter claimed.

1. A battery engagement structure used in a portable battery charging module and adapted to engage a battery pack for charging by said portable battery charging module, the battery engagement structure comprising:
a housing, said housing comprising a bottom panel, a first side panel, and a second side panel, wherein said first side panel having an inner face, said second side panel abutted against one end of said first side panel, a battery engagement opening disposed at said first side panel, a sliding groove disposed at said first side panel in parallel to said inner face of said first side panel, a button hole disposed at said second side panel, and a pivot holder upwardly extended from said bottom panel adjacent to the connection area between said first side panel and said second side panel;
a button mounted in said button hole;
an operation mechanism, said operation mechanism comprising a locking bar, and a link, wherein said locking bar mounted in said sliding groove and movable along said sliding groove in and out of said battery engagement opening, said locking bar having a front end insertable into said battery engagement opening, said link having a first end, a second end, and a middle part, said first end coupled to said locking bar, said second end stopped at said button, and said middle part pivoted to said pivot holder; and
spring means adapted to impart a prestress to said locking bar to force the front end of said locking bar inserted into said battery engagement opening.

2. The battery engagement structure as claimed in claim 1, wherein said housing is comprised of a top cover shell and a bottom shell, and said bottom panel is formed in said bottom shell.

3. The battery engagement structure as claimed in claim 1, wherein said housing further comprises at least one rib defining said sliding groove; said locking bar further comprising a supporting rod; one end of said spring means is sleeved onto said supporting rod and another end of said spring means is stopped against said at least one rib.

4. The battery engagement structure as claimed in claim 1, wherein said housing further comprises a guide rod upwardly extended from said bottom panel adjacent to said first side panel; said locking bar of said operation mechanism further has an oblong guide hole coupled to said guide rod.

5. The battery engagement structure as claimed in claim 1, wherein the middle part of said link has a pivot hole pivotally connected to the pivot holder of said housing by a screw.
